(19) United States
(12) Patent Application Publication
(10) Pub. No.: US 2002/0028706 A1
(43) Pub. Date: Mar. 7, 2002

(54) Method and system for pool betting

(76) Inventors: Christopher J.D. Barnard, Toronto (CA); Marc B. Lavine, Toronto (CA)

Correspondence Address: Santosh K. Chari, Orange & Chari, 66 Wellington Street West, Suite 4900, P.O. Box 190, Toronto, ON, M5K 1H6, CA

(21) Appl. No.: 09/977,963

(22) Filed: Oct. 17, 2001

Related U.S. Application Data
(63) Continuation-in-part of application No. 09/373,736, filed on Aug. 13, 1999.

(51) Int. Cl. G06F 19/00

(52) U.S. Cl. 463/26

(57) ABSTRACT

A system and method for playing a pooled-betting game in a communication network, the game being associated with an event. The system provides a pool engine that permits multiple pools to be managed and operated by a single site manager. The pool information is continuously updated as new entries occur via the Internet. The system is flexible and permits new pools and new pool providers to be added to the site with ease. The pool engine also manages the crediting of the site providers and the site manager with predetermined portions of entry fees.

This is a Continuation in Part application of U.S. application Ser. No. 09/373,736, filed Aug. 13, 1999, the content of which is incorporated herein by reference.

### FIELD OF THE INVENTION

The present invention relates to a method and system for on-line, or Internet-based, gambling. In particular, the present invention relates to a method and system for playing online pooled-betting games.

### BACKGROUND OF THE INVENTION

With the more widespread public acceptance and government approval of gambling, the gambling industry, including lotteries, sports betting, and casino gaming, continues to expand. The number of on-line wagering and gambling systems, particularly those that are Internet-based, has dramatically increased in recent years, particularly now that e-commerce can provide greater security and efficiency in the exchange of funds between consumers and Internet providers.

One area of gambling that has not been exploited as fully as possible by the use of the Internet is pool betting. The reasons for this include the fact that regulatory schemes have not yet extended to include pool betting over the Internet, as well as the complexity of managing and updating pools to provide users with accurate information on an ongoing basis. Prior art pool betting schemes are handicapped in that individual organizations providing these games often find it difficult to attract substantially large numbers of players in order to increase the jackpot prize. This is important since the jackpot prize is proportional to the number of players in a particular pool.

It is therefore an object of this invention to mitigate at least one of the above-mentioned disadvantages.

### SUMMARY OF THE INVENTION

In one of its aspects, the present invention provides a method and system for operating an online pooled-betting system. The method begins by providing at least one game, accessible to a player through an Internet site included on one or more servers. The game is managed by a pool engine and each game has a pool associated with it. The game information, such as available picks, odds and payout, is displayed to the player, generally in response to the player's input. An entry request is made by the player, including an entry fee. Preferably, the entry fee is set by the system, and thus the entry fee is paid once, rather than on the occasion of each subsequent pick. The entry request is transmitted to the pool engine. A security identifier is then requested from the player to confirm the transfer of the entry fee from the player's credit facility to the pool engine. After the entry fee has been transferred to the pool engine, the pool is subsequently updated to reflect the addition of the entry fee, and the pool information is revised accordingly. Also, a predetermined portion of the entry fee is credited to the game provider and the site manager according to a predetermined apportionment structure.

Thus, in one embodiment, the invention provides a method of playing a pooled-betting game between a plurality of players over a communication network, the pooled-betting game being based on an event, the method having the steps of:

associating each player with a point of access to the game;

coupling the player to a pool engine for processing an entry request to the game, the entry request being associate with payment of an entry fee;

transferring the entry fee from each of the players to a pool;

the pool engine determining a winner of the game in accordance with an outcome of the game; and,

awarding the pool to the winner.

In another embodiment, the invention provides a method of playing a head-to-head game based on an event, the game comprising the steps of:

(a) presenting at least one game associated with a pool to at least one player;

(b) allowing the at least one player to make an entry associated with payment of an entry fee;

(c) coupling the at least one player to a pool engine for processing the selection;

(d) transferring the entry fee from the at least one player to the pool and updating the pool information, the pool being associated with a total amount of the entry fee;

(e) the pool engine determining the number of selections in the pool and creating pairings of non-matching selections;

(f) the pool engine determining a winner of the pairing based on the at least one player's outcome;

(g) repeating steps (a) to (e) until there exists only one pairing; and

(h) awarding the pool to the winner of the remaining pairing.

In yet another embodiment, the invention provides a method of playing a head-to-head game based on an event, the game comprising the steps of:

(a) presenting at least one game associated with a pool to at least one player;

(b) allowing the at least one player to make an entry associated with payment of an entry fee;

(c) coupling the at least one player to a pool engine for processing the selection;

(d) transferring the entry fee from the at least one player to the pool and updating the pool information, the pool being associated with a total amount of the entry fee;

(e) the pool engine determining the number of selections in the pool and creating pairings of non-matching selections;

(f) the pool engine determining a winner of the pairing based on the at least one player's outcome;

(g) repeating the steps of (a) to (e) until there exists only one pairing; and

(h) awarding the pool to the winner of the remaining pairing.

### BRIEF DESCRIPTION OF THE DRAWINGS

These and other features of the preferred embodiments of the inventor will become apparent in the following defined description in which reference is made to the appended drawings wherein:

FIG. 1 shows a gambling-system according to the present invention;

FIG. 2 shows the functional components of the system of FIG. 1;

FIG. 3 shows the components of the pool management services component of FIG. 2;

FIG. 4 shows a screenshot of a browser interface associated with a beneficiary as a point of access, including an indicium associated with the beneficiary;

FIG. 5 shows a screenshot of a browser interface associated with a benefactor, including an indicium associated with the benefactor as a point of access and the beneficiary as chosen by the player;

FIG. 6 shows a screenshot of a browser interface associated with a benefactor, including an indicium associated with the benefactor as a point of access, the beneficiary as chosen by the player and the URL of the game provider transmitted to the player;

FIGS. 7a to 7d show a method for operating the gambling system of FIG. 1 with respect to a “head-to-head” game;

FIGS. 8a to 8c show a method for operating the gaming system of FIG. 1, in another embodiment with respect to a “collecting pool” game.

### DETAILED DESCRIPTION OF THE PREFERRED EMBODIMENTS

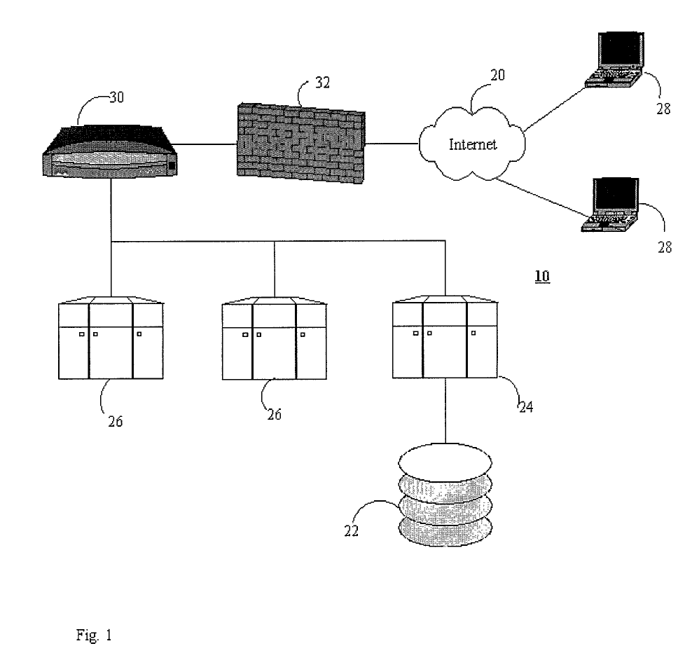

Reference is first made to FIG. 1, which is an overview of a system for facilitating a method for playing a betting game, shown generally by the numeral 10, in a preferred embodiment. The system 10 provides gambling, particularly consisting of pool-betting on events, such as sporting events, entertainment-related events or financial events, via a communications network 20. It will be appreciated by persons skilled in the art that any network such as a local area network (LAN), a wide area network (WAN), the Internet or a wireless system may be used. The system 10 consists of a gaming site database 22 communicating with a game server 24 communicatively coupled to web servers 26. The web server 26, which may be a hypertext transfer protocol (HTTP) server, is a process running at a web site which serves web pages in response to HTTP requests from web browsers on user terminals 28. As is well known in the art, HTTP is a protocol for use on the World Wide Web (WWW) and defines how messages are formatted and transmitted, and what actions web servers 26 and web browsers should take in response to various commands. Each web page is associated with a uniform resource locator (URL) pointing to a location of an object on the web server 26, thus any web page' may be accessed by entering an appropriate URL in a web browser.

In a preferred embodiment, the game server 24 is a database server such as a ProLiant 55008 running Microsoft SQL Server 6.5, and web servers 26 are ProLiant 30008 servers running Microsoft IIS 4.0. In the illustrated embodiment, two web servers 26 are shown, however, as will be apparent to those of skill in the art, any number of web servers 26 can be used depending on the load requirements of the system 10. Also, though the present invention is described with reference to a single game server 24, multiple game servers 24 can be coupled to multiple web servers 26, as desired. Generally, the game server 24 and the web servers 26 are chosen such that they are upwardly scalable, and easily integrated with each other and with the desired operating system, such as Microsoft Windows NT 4.0. Content replication between the web servers 26 can be accomplished through the use of Microsoft Site Server 3.0. This also permits relatively inexpensive incremental use of other included components, such as the Microsoft Personalization Service.

The web servers 26 are in communication with a local director 30, a configurable hardware device that evenly balances web requests between a plurality of web servers 26. In a presently preferred embodiment, the local director 30 is a Cisco LocalDirector from CISCO Systems, San Jose, Calif., USA. The web servers 26 can be automatically and transparently placed in or out of service, and the local director 30 is equipped with a hot standby failover mechanism, eliminating points of failure for the server farm or cluster. The local director 30 is coupled to the Internet 20 via a firewall 32. Typically, the firewall 32 may be a sub-system of computer software and hardware that intercepts data packets before allowing them into or out of a communication network, such as the Internet 20. The firewall 32 determines whether or not to allow data packets to pass based upon a security policy. However, the firewall 32 may be implemented wholly in hardware or software, as desired by the provider of system 10.

The number of user terminals 28 that can be coupled to system 10 at any one time depends on the number and functionality of the web servers 26, as well as the capabilities of the game server 24. The user terminals 28 are typically computing devices that are, but not limited to, personal computers, handheld devices, cell phones, pagers and microprocessor-based wireless information devices. The user terminals 28 include a processing unit, a computer readable medium including ROM, flash memory, non-volatile RAM, a magnetic disk, an optical disk, an IC memory card or a magnetic tape. Also, the user terminals 28 execute an operating system such as Microsoft® Windows 2000, Windows CE, UNIX, EPOC, Pocket® PC OS or Palm OS®. The user terminals 28 are communicatively coupled to the Internet 20 via a dial-up modem, a broadband connection (Cable/xDSL, wireless), or via a direct connection. Also included in the computer readable medium of the user terminals, is a suitable web browser application, such as Microsoft Internet Explorer, or Netscape Navigator for requesting and receiving the web pages from web servers 26.

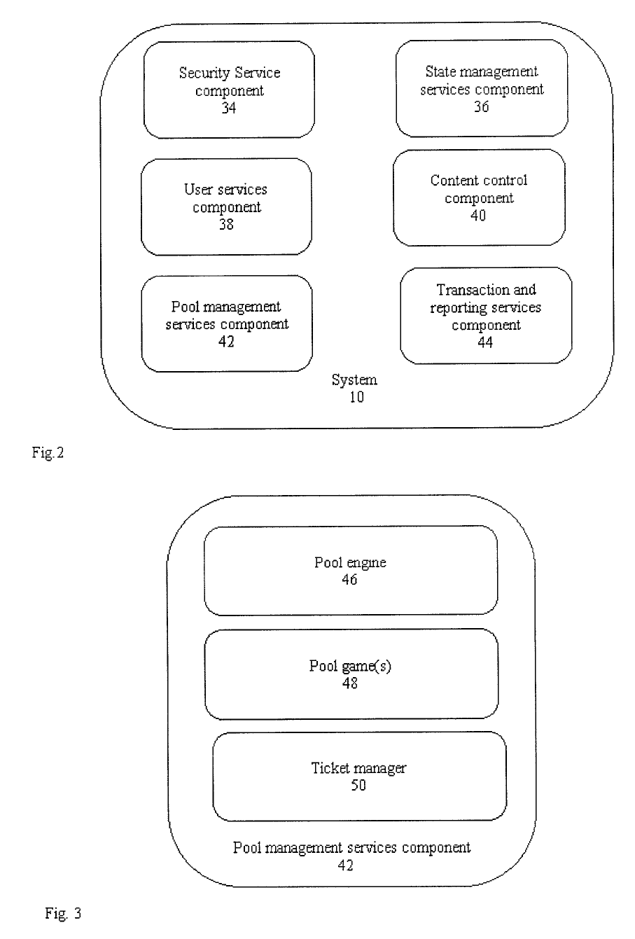

The integrated functions of the system 10 are shown in a block diagram in FIG. 2. The system 10 includes a security services component 34, a state management services component 36, a user services component 38, a content control component 40, a pool management services component 42 and a transaction and reporting services component 44. These services can be implemented on the game server 24, web servers 26, firewall 32, or a combination thereof.

In more detail, the security services component 34 is the infrastructure that secures the integrity of all the pool, personal and account information via electronic means in real-time. Process-related security issues relating to physical tampering with the servers or other hardware are not generally within the scope of the security services component 34. Firstly, the firewall 32 provides a security service, as described above. Secondly, information relating to credit information, e-commerce transactions, personal information, etc. is encrypted. Any appropriate encryption protocol, such as secure socket layer (SSL) 3.0 or Internet Protocol security (IPSec), can be used. However, as there is a severe speed compromise associated with encryption of data, this may be limited to the encryption of transmission/confirmation of financial information only. Thirdly, the users of the system 10 are assigned a unique personal identification number (PIN), which is required to authenticate certain transactions, such as financial transactions.

The state management services component 36 allows the system 10 to maintain state information from web page to web page as a user or administrator navigates the system 10. The typical functions that are provided by the state management services component 36 include determining whether a user has logged in, timing a user out after a specified period of inactivity, retrieving personalized web page information according to a user's preferences, or caching repeatedly accessed web pages or information. Session variables can be used to manage the state of each session connected to the system 10. For example, a one-time cookie can be pushed down to the user terminal 28, with which the user terminal's 28 browser identifies itself during every request made of the web server 26. Generally, a cookie is a packet of information sent by an HTTP server to a browser and then sent back by the browser each time it accesses that server. Cookies can contain any arbitrary information the web server 26 chooses and are used to maintain state between otherwise stateless HTTP transactions. Typically, a cookie may be used to authenticate or identify a registered user of a web site without requiring the user to sign in every time the user accesses that site. Other uses may include maintaining a “shopping basket” of goods selected for purchase during a session at a site, site personalization such as presenting different pages to different users, and tracking a particular user's access to a site.

The user services component 38 includes membership, registration, personalization and integrated communication services. Registration, membership and basic user preferences can be stored effectively using a Microsoft SQL Server, alongside customer, account and transaction information, in the gaming site database 22 and accessed through the game server 24. Further personalization can be added through available personalization packages, such as Microsoft Site Server 3.0, Open Sesame Learn Sesame, Firefly Passport Office, and Firefly Passport. The choice of personalization package depends largely on the degree of customization that a gambling system operator wants to permit, and the size and capabilities of the system 10. The integrated communication services include the automatic registration of a user, and the automatic sending of notification and confirmation messages. Also, automatic e-mail messages can be sent to a user registering as a player on the system 10, changing the player's personal information, purchasing a ticket, or performing a transaction corresponding to the player's debit account. In addition, players can be automatically sent reminders of upcoming gambling events. Several applications can be used to implement the integrated communication services, such as ASPMail, ListCaster and Microsoft SQL Mail.

The content control component 40 includes such services as dynamic marketing devices and push advertising. These services can be delivered by integrating such applications as NetGravity AdServer or Microsoft AdRotator for providing push advertising tailored to a user's preferences. Similarly, an application such as Macromedia Flash can be used to create avatars and add sound as a player is interacting with the system 10.

The transaction and reporting services component 44 includes logging and tracking all player and system transactions, such as login, registration and payment transactions, as well as all querying and displaying of operational and point-in-time information. Transaction and reporting services may be integrated with any back-end systems, such as accounting software, etc.

As shown in greater detail in FIG. 3, the pool management service component 42 includes a pool engine 46, a pool game 48 and a ticket manager 50. The pool engine 46 manages all the games 48, as well as the player's unique identifier and the corresponding challenge response, game picks, game states, and the available choices for a particular user and a particular game 48. Also, the pool engine 46 provides a single back-end solution for the management of a plurality of pools, and since the pool engine 46 is a modular shell, it can be extended and scaled to continuously add new games 48. The ticket manager 50 displays and stores the player selections for one or more games 48, while also keeping track of the ticket state, that is, whether it is paid, unpaid or cancelled. The ticket manager 50 also provides a random pick selector, which makes a default pick when needed.

The pool game 48 includes the game information that is displayed to the player, and the ticketing process for acceptance of a player's entry to the game. The games 48 can be offered in multiple formats, and may include single event pools, single event pools with ranked/calculated outcomes, multiple event pools with a discrete outcome, multiple event pools with special rules and multiple event pools with ranked/calculated outcomes. Single event pools are those in which a player must pick the precise outcome or placement (e.g. winner, loser, 2nd) of a single event, such as a sporting event or awards ceremony such as the OSCARS®. Single event pools with ranked/calculated outcomes are those where the winning pick is a based on performance over a time period, such as the best performing stock. Multiple event pools with discrete outcomes depend on the results of a discrete series of single events that the player must pick exactly. Multiple event pools with special rules include “guts” and “suicide” pools, and are specialized pools that require further picks part way through the process, further payment to continue, partial payout at specified intervals, etc. Multiple event pools with ranked calculated outcomes, such as an NCAA® bracket pool, or a pool to pick the top 5/10/15 money-winners on a particular pro tour, typically have a score assigned to each successful pick, with the final score determining the final outcome.

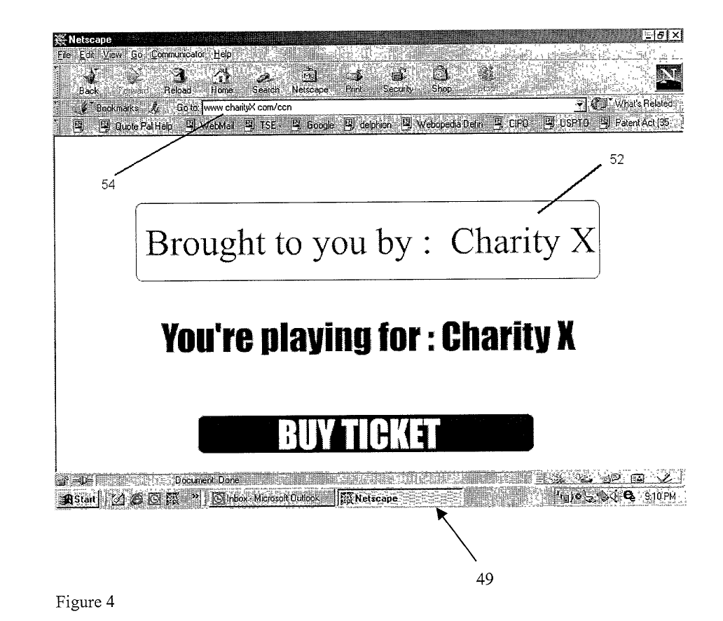

A user interface 49 for the system 10 is shown in FIGS. 4-6. The user interface 49 may be designed according to well-known web site design principles, and it generally includes a number of linked hypertext markup language (HTML) pages, some of which merely provide information, and some of which require user input. As is well known to those of skill in the art, HTML is an authoring language used to create documents on the World Wide Web.

As mentioned above, one of the problems faced by individual organizations is the ability to create an event that is large enough to result in a substantially large jackpot. The system 10 of the present invention obviates this shortcoming by allowing co-branding of the pool on the websites belonging to partners affiliated with the system provider. Such partners may include benefactors or beneficiaries, which promote an event on their websites by using a plurality of marketing methods such as, providing an up-to-date indicium displaying the current jackpot prize. The indicium may be a real-time scrolling ticker reflecting the prize as drawn from the total revenues of the entire network, that is, the total entry fees from each player. Generally, player participation may be substantially increased through this consolidated jackpot, as this offers players at each individual website a more compelling reason to join. For example, if 1% of a population purchases a ticket to a contest with a prize of $10,000, that rate might become 1.5% if the jackpot is $100,000. As an additional incentive, each partner is rewarded by the system 10 or game provider for each user that accesses the system 10 through that partner's portal.

The method of the present invention will now be described with reference to FIGS. 4-8. The method begins with the provision of at least one game 48 at an Internet site. The game 48 is displayed to any player that enters the system 10, but is only accessible to users who have registered with the system 10 through the user services component 38. As used herein, a player is such a user who has registered with the system 10. In a preferred embodiment, the game 48 is a pooled-betting game, meaning that the game 48 has a pool into which a portion of each player's entry fee is added. The winner, that is, the player having the winning choices or picks as determined by the individual game rules, collects the pool jackpot prize.

Due to the very nature of the Internet 20, the system 10 is available to any user terminal 28 coupled to the Internet despite the geographic location (i.e. region or country etc.). This presents a challenge as the system 10 requires configuration for operation in different jurisdictions, such as Canada, the United Kingdom and the United States of America, in order to comply with the jurisdictional laws, taxes and associated fees. Depending on the jurisdiction, the game provider may require a gaming license in order to offer the pooled betting game. The partner may also require a license to offer the pooled betting games 48 and to receive a portion of the entry fee.

Referring to FIG. 4, in a jurisdiction such as Canada where both the partner 52 and the game provider require licenses to operate, if the game server's URL is www.cpn.com (which is used to designate a hypothetical site such as, for example, “Charity Pool Network”) and the URL of the partner is www.charityX.com), then the URL of the game server 24 (www.cpn.com) is not transmitted to the player and only the partner's URL 54 (www.charityX.com/cpn) is visible. In essence, the player remains on the partner's 52 website for the duration of the gambling session, despite all the back-end operations being administered by the game server 24 of the system 10. As indicated above, “cpn” is used herein to designate a hypothetical web site. It will be appreciated by persons skilled in the art that the URL for the game server may be any other web site. It will also be understood that the URL www.cpn.com is not intended to designate any past or present web site and is used herein purely for the purposes of illustrating the invention.

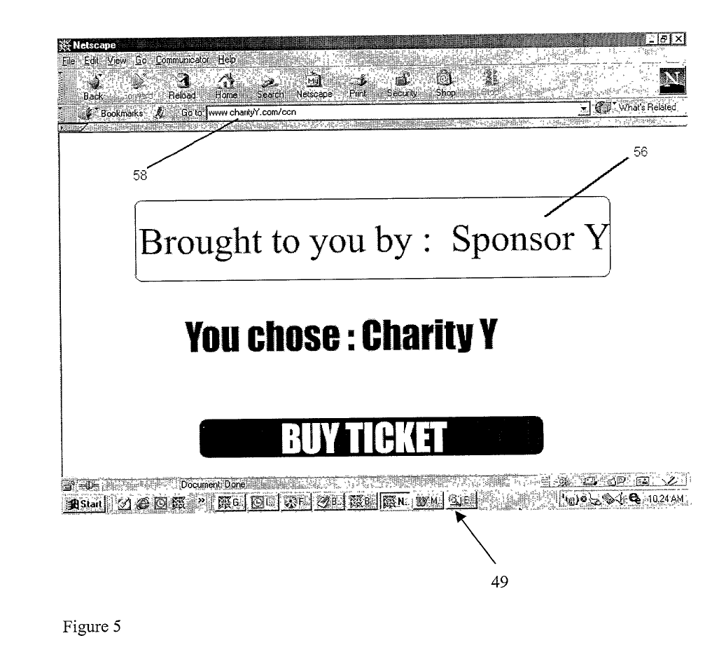

Alternatively, FIGS. 5 show a user interface 49 presented to the user having accessed the system 10 via a benefactor's website (www.sponsorY.com), and having chosen a beneficiary (CharityY) as the default recipient.

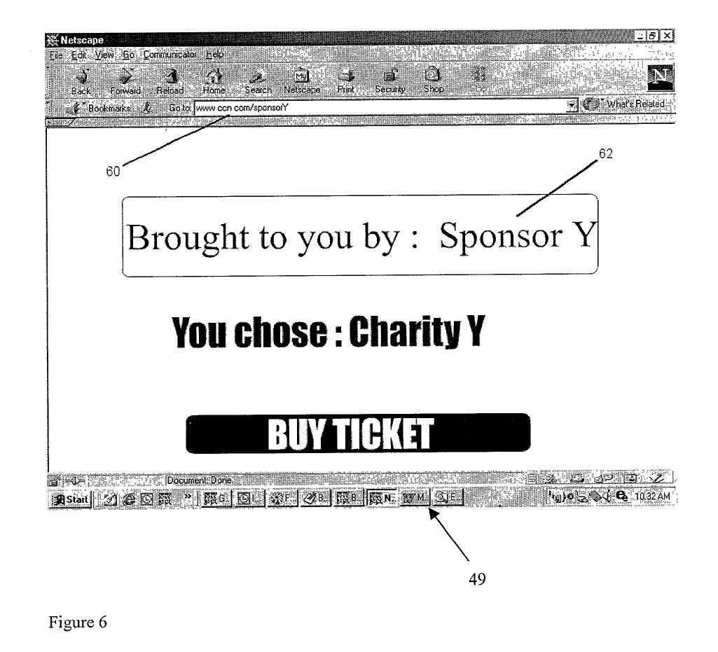

In another instance, as shown in FIGS. 6, where only the game provider requires a license, then the game server's URL 60 (www.cpn.com/sponsor) is transmitted to the player, such that the player exits the partner's 62 website. The transparency of the redirection of the player from the partner's URL (www.sponsorY.com) to the game server's URL (www.cpn.com/sponsor) is achieved by associating each point of access to the system 10 with a unique identifier, which may include an IP address or a URL.

### Description of Head to Head Games

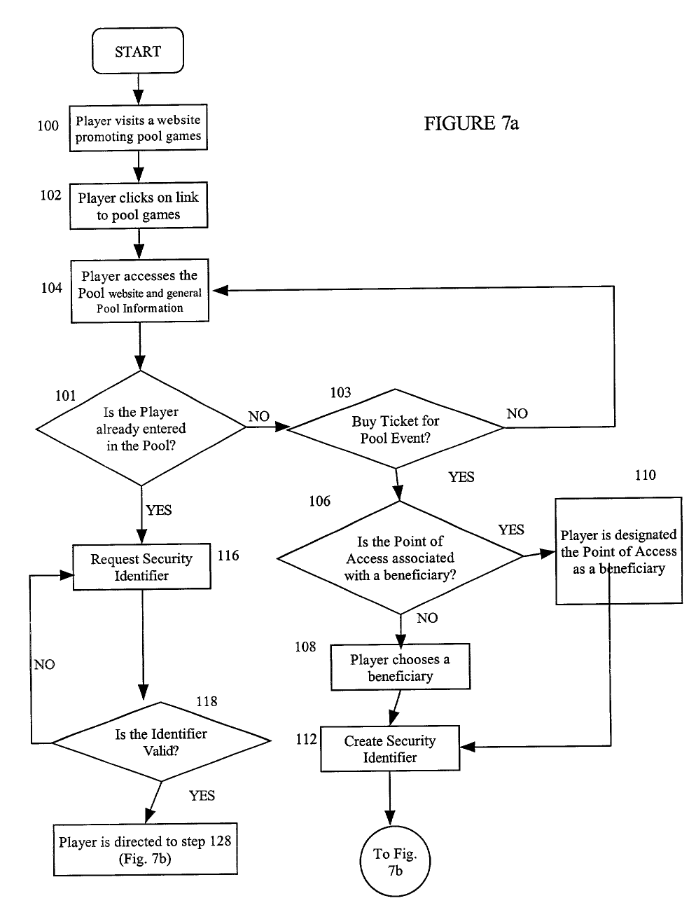

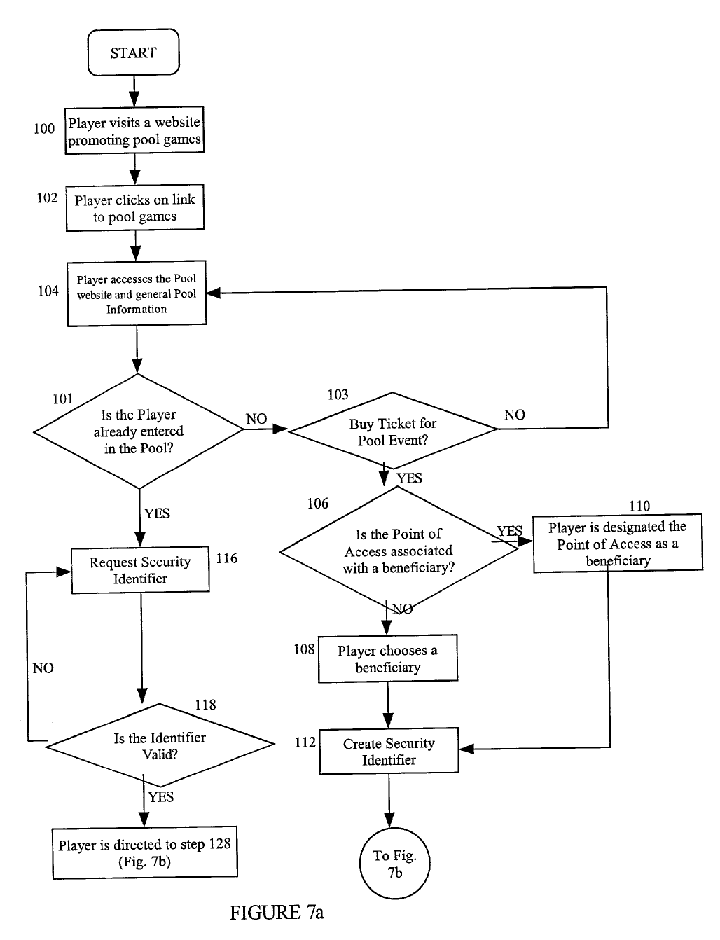

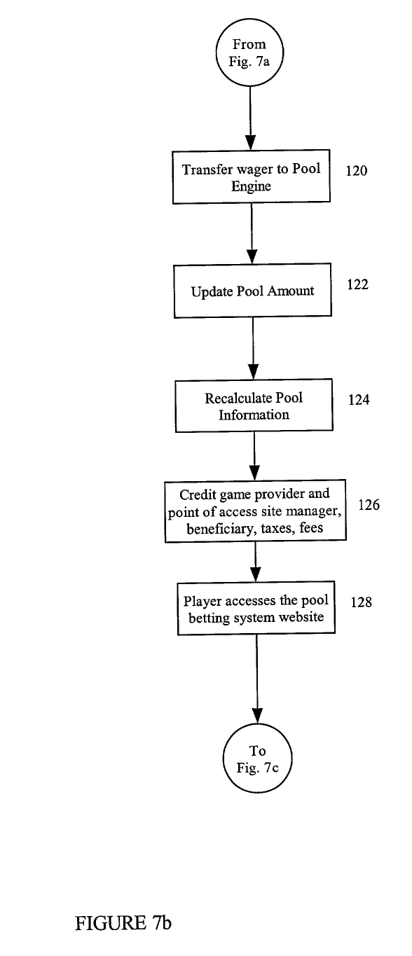

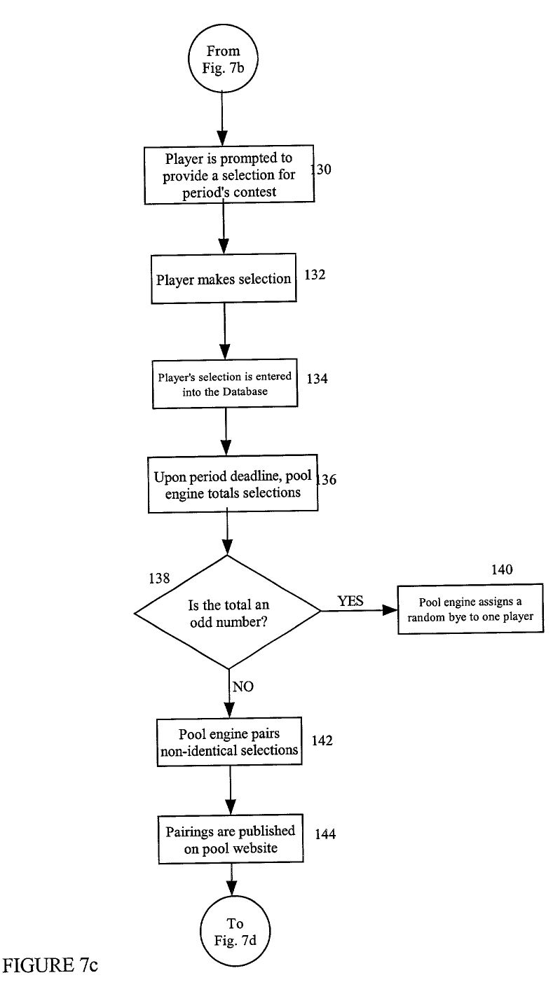

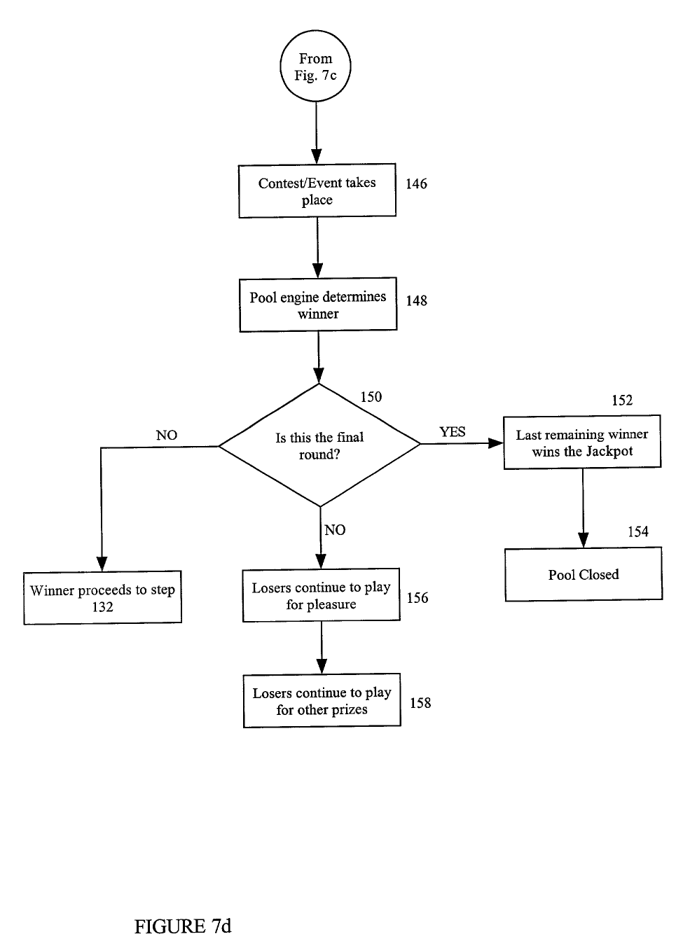

Looking at FIGS. 7a-7d, which show flow charts describing a method of playing a head-to-head pool game 48; the head-to-head pool game 48 is designed such that there is only one winner for a plurality of players. In one embodiment, each player is allowed to select any eligible team/player/stock/etc. only once during the course of the pool. Thus, the pool engine monitors each contestant's selections and determines whether this condition has been met.

In operation, the process for playing a pooled betting game starts with a user visiting 100 a website promoting at least one pool game 48, such as a head-to-head pool game. As mentioned above, a partner affiliated with the provider of the system 10 typically manages such a website. The pool game 48 is associated with at least one event such as the Academy Awards® Ceremony or a sporting event.

The player follows 102 a link on the partner's website to the pool games 48 of the system 10. Subsequently, the user accesses 104 the pool website and is able to view the general pool information corresponding to at least one game 48. The pool information includes the specific game rules, the ticket entry price, the size of the pool, which is continuously updated to reflect its growth, the anticipated payouts and other information that is relevant to the player in deciding whether to participate in the game, and as prescribed in relevant gaming regulations. Depending on the jurisdiction as described above, the URL of the game server 24 may or may not be transmitted at this stage to the player, as shown in FIGS. 4 to 6.

At this point, a determination 101 is made to see if the user, or player, has already entered the pool and is re-visiting the site. If the player has previously entered the pool, the player is directed 116 to enter a pre-assigned security identifier in order to gain access to the pool. This and subsequent steps will be discussed further below.

If the player has not previously entered the pool, the player is prompted 103 to purchase a ticket to enter the pool. If no ticket is purchased, the player is returned to the general pool information page 104. If a ticket is purchased, the player continues to further screens as described below. The player may be provided with several options as a means of payment for the ticket, which may include credit card payment, debit card payment, pre-payment, credit facilities provided by the game provider, or other forms of electronic payment as will be apparent to persons skilled in the art.

Once a ticket is purchased by the player, a determination 106 is made of the beneficiary of the charitable portion of the entry fee. If the player's point of access is a benefactor's website, then the player chooses a beneficiary from a list 108. If the point of access is a beneficiary's website, then the player is designated that beneficiary as the recipient 110.

After the beneficiary has been assigned, the player is then assigned, or provided 112 with a unique security identifier. In one embodiment, the security identifier can be a personal identification number (PIN); however, it will be apparent to persons skilled in the art that any other type of identifier may be used in the invention.

Once the beneficiary has been chosen, the player's entry fee, or wager, is transferred 120 to the pool engine 46. Then, at step 122, the pool amount, the total sum of entries made by previous players of the game 48, is updated by adding the new entry fee, less a predetermined amount as determined by the system 10, to the pool amount. The predetermined amount that is withheld is generally a percentage of the total entry fee, and is due to a number of recipients including the beneficiary. However, the predetermined amount can also be a set fee, or the entry fee may include a minimum set fee.

Next, at step 124, the pool information is updated to reflect the updated pool amount, and to recalculate other dependent pool information, such as odds and expected payouts. Finally, at step 126, the predetermined amount withheld at step 122 is credited the game provider, the site manager, the beneficiary and jurisdictional fees and taxes according to a predetermined apportionment. Following this, the player then accesses 128 the betting system website.

Returning again to the determination at 101, if, as indicated above, the player is reentering the pool, then he is directed 116 to enter the security identifier that was assigned in the first visit. The identifier is then verified 1 18 and, if valid, the player is then permitted to access 128 the betting system website. If the identifier is found invalid, the player is returned to the prompt 116 to re-enter a valid identifier.

Once in the pool game domain 128, the player is prompted to make a selection for the period's contest, in step 130. Following which, the player is allowed to enter the selection in a predetermined time period as dictated by the system 10. The selection consists of a specific pick, or a range of picks, as determined by the particular game rules. In step 134 the ticket manager 50 issues and stores the ticket in the database 22, after which the pool engine determines 136 the pairing of the players for the head-to-head games 48. The pairings are determined according to the entries following the expiry of the predetermined time period. Ideally, when the player has accessed the pool betting system website, 128, the pool engine generates reports encompassing various aspects of the pool game 48 in any given period. Such aspects may include, for example, top performers of the week; top performers on the season, selection frequency for players, teams, and so forth; as well as statistical information for each player, details of the selections made each week, and the outcome. As an example, the step of prompting a player for a selection 130 may further include the step of periodically notifying the player of information related to the outcome of the player's previous forecast and updated status. For example, the notification may occur on a weekly basis, in which case the player is prompted to submit a selection for the coming week. Generally, the player is informed of a time period for which to make a selection, after which, failing submission, the pool engine will determine a randomly generated legal selection. That selection, whether submitted or generated by the engine, will serve as the player's selection for that week's match. Those players whose selections win remain in contention for the jackpot. Those who do not may continue to play for entertainment purposes only by accumulating wins and losses in pursuit of prizes based on overall record. Therefore, all players are eligible for weekly prizes, regardless of their success to that point.

The pool engine thus calculates 138 the total amount of selection entries. If the total amount is an odd number, then one entry or player is randomly assigned a bye into the next round 140; however, if an even number then the pool engine creates pairings 142 in which the players have different selections, thus ensuring that each player's single selection will be sufficient. Also, the pool engine creates parings by substantially ensuring that undefeated players are paired with other undefeated players; and that multiple entries made by the same player do not meet unless unavoidable. Once the pairings have been completed, the resulting pairings indicating the player's unique identifier are posted 144 on the website. It is understood, however, that the pairings may be communicated to the players by a number of methods, such as, electronic mail, ‘snail’ mail, SMS messaging or voice mail. All information associated with the particular game in the current session, such as, the selection made by the player or the pairing and ticket information may be available for download to the user terminal 28.

After the event takes place in step 146, the pool engine reviews the pairings in order to determine 148 a winner. A determination is made as to whether the previous round was the ultimate round 150. If that was the last round then one player wins the jackpot 152, or else the winner makes another selection 132 and the process starts over again until the last remaining player wins the jackpot in step 152. After the winner of the jackpot has been chosen 152, the pool is subsequently closed 154. However, play may continue as the losers from each round are directed to a consolation section where they continue to play for entertainment purposes only 156, although with a possibility of winning other prizes 158.

In the aforementioned example, players may buy as many tickets as they please, with each ticket providing a unique opportunity to win, and eligibility for all the prizes. Tickets may be available for purchase for a specified period preceding the commencement of an event, and continue to be available through a predetermined period of time after the commencement of the competition, although the ticket price may escalate as the competition progresses. Alternatively, the cost of entry may remain constant, whereas the number of entries at that price decreases each period until sales close. The players compete to forecast an event more successfully than their single opponent does that week, with success being measured relatively, rather than absolutely. If the task is to choose the highest scoring team in the weekend game, the player in a given pair whose team scores more wins, regardless of how the performance of that team compares overall. The pool length is predetermined and specified in the rules accompanying each individual pool. The time frame to win the jackpot is determined by the number of entries, and the entry pattern. When the entry to the pool has closed, the number of entries still eligible for the grand prize determines how many more periods until the jackpot is won.

As will be noted from the above discussion, when a player returns to the game website for subsequent selections and information, they need only enter their valid security identifier and access the game 128. Thus, as will be appreciated, purchasing a ticket and entering the game occurs only at the player's first visit. It will also be noted that the pool information is not updated with every visit and that only a ticket sale affects the pool information. Of course, other variations of the game and access thereto will be apparent to persons skilled in the art.

### Description of Collecting Pool Games

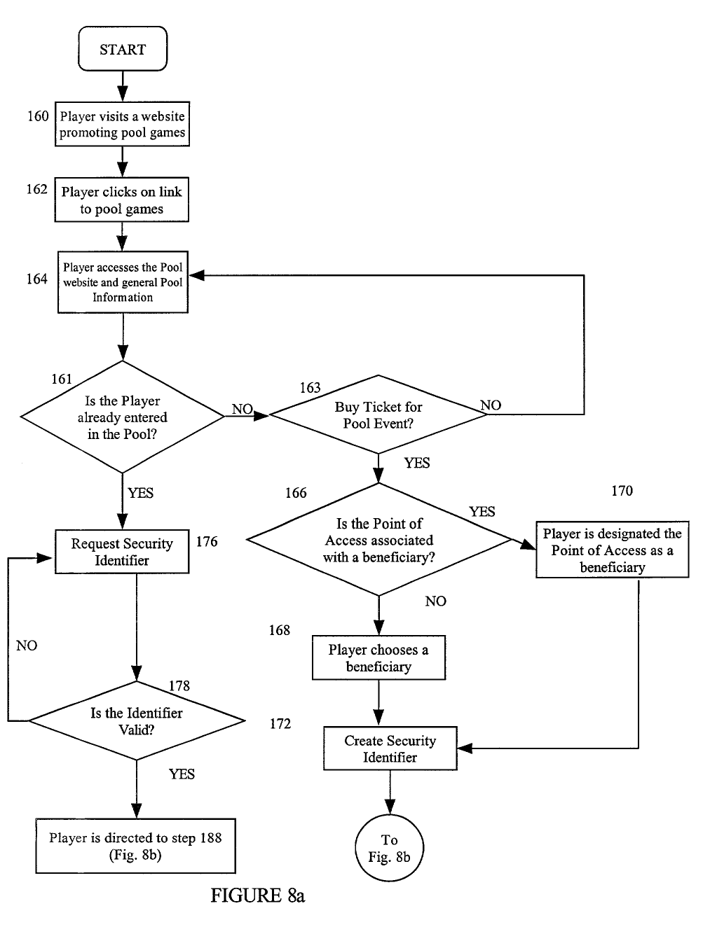

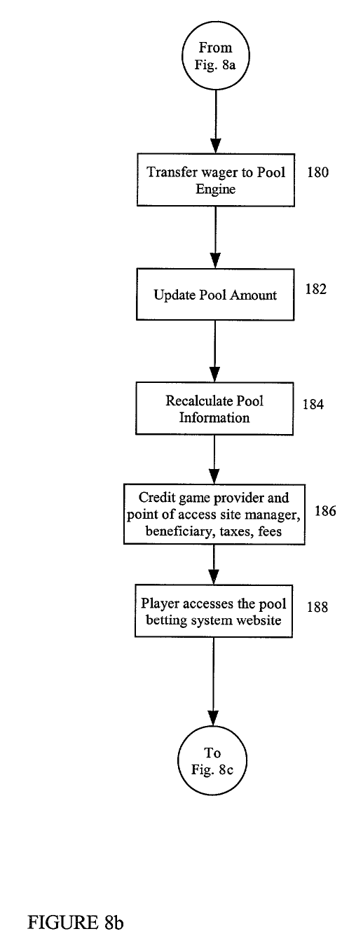

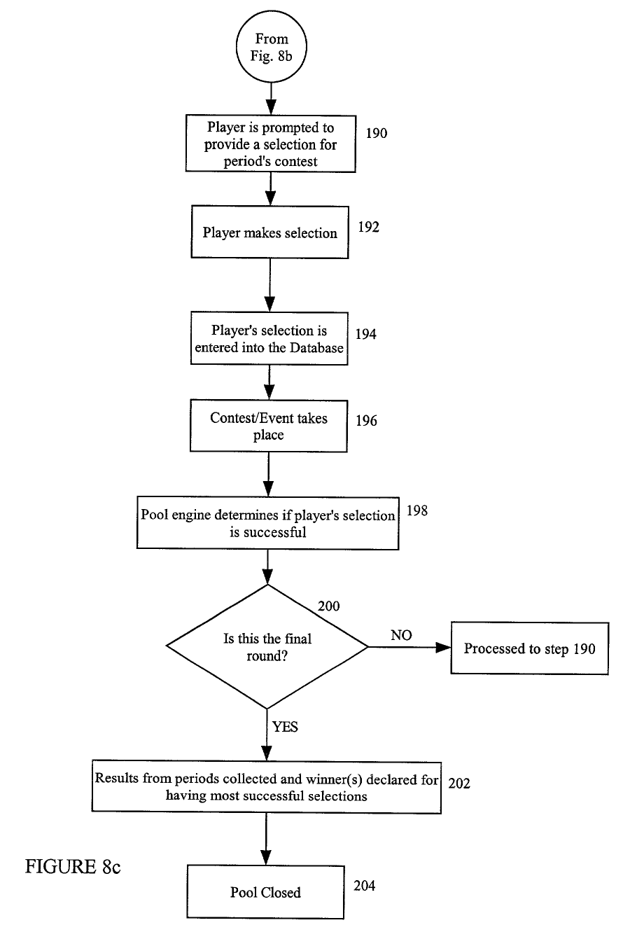

In another embodiment, as illustrated in FIGS. 8a to 8c, the present invention provides a game of collecting pools wherein players compete to acquire components to complete a pool portfolio. Once again, the players' entry fees are pooled to form a jackpot, which is awarded to the player or players who complete(s) the portfolio first. The pool engine is configured to accept selections from the players, determine their success or failure based on the outcome, and acknowledge that success by awarding credit in the categories successfully completed, and substantially ensuring that subsequent selections can only be made in unfilled categories. Thus each entry is provided with its own unique profile.

In this pool, the portfolio to be filled will include several distinct categories (i.e. Stock market pool: Technology; Financial sector; Oil and Gas, and so forth). For each of these categories, a system administrator makes a selection. These selections are posted on the website at the beginning of each selection period. The player can examine the administrator's selections, and select which category to compete in. In this category, the player makes a selection that is different from the administrator's. After the selection has been made in a predetermined time period, the event occurs. If the player's selection outperforms the administrator's, the player fills the category, and receives credit for doing so. The process repeats for each of the periods of the pool. The first player to complete the entire portfolio, or the player having the best results at the close of competition wins the jackpot.

As shown in FIG. 8a, the process starts with a player visiting 160 a website promoting at least one collecting pool game 48 associated with a plurality of categories. The player follows a link 162 on the partner's website to the pool games of the system 10; the link may be a hypertext link, a banner or a scrolling ticker. Subsequently, the player accesses 164 the pool website and is provided with an opportunity to view the pool information for at least one game 48. The pool information includes details as described above. Depending on the jurisdiction as described above, the URL of the game, as shown in FIGS. 4 to 6 may or may not be transmitted to the player at this stage.

The following sign on steps are similar to those described above with respect to the embodiment depicted in FIG. 7. Specifically, a determination 161 is first made to see if the user, or player, has already entered the pool and is re-visiting the site. If the player has previously entered the pool, the player is directed 176 to enter a pre-assigned security identifier in order to gain access to the pool. This and subsequent steps will be discussed further below.

If the player has not previously entered the pool, the player is prompted 163 to purchase a ticket to enter the pool. If no ticket is purchased, the player is returned to the general pool information page 164. If a ticket is purchased, the player continues to further screens as described below. As before, the player may be provided with several options as a means of payment for the ticket, which may include credit card payment, debit card payment, prepayment, credit facilities provided by the game provider, or other forms of electronic payment as will be apparent to persons skilled in the art.

Once a ticket is purchased by the player, a determination 166 is made of the beneficiary of the charitable portion of the entry fee. If the player's point of access is a benefactor's website, then the player chooses a beneficiary from a list 168. If the point of access is a beneficiary's website, then the player is designated that beneficiary as the recipient 170.

After the beneficiary has been assigned, the player is then assigned, or provided 172 with a unique security identifier. In one embodiment, the security identifier can, as before, be a personal identification number (PIN); however, it will be apparent to persons skilled in the art that any other type of identifier may be used in the invention.

Once the beneficiary has been chosen, the player's entry fee, or wager, is transferred 180 to the pool engine 46. The transfer 180 of the entry fee to the pool engine 46 initiates a series of processes within the pool engine 46. First, at step 182, the pool amount, the total sum of entries made by previous players of the game 48, is updated by adding the new entry fee, less a predetermined amount as determined by the system 10, to the pool amount.

Next, at step 184, the pool information is updated to reflect the updated pool amount, and to recalculate other dependent pool information, such as odds and expected payouts. Finally, at step 186, the predetermined amount withheld at step 182 is credited the game provider, the site manager, the beneficiary and jurisdictional fees and taxes according to a predetermined apportionment. The player then enters 188 the game domain and accesses the pool and betting system website.

As indicated above, the player may be re-visiting the game. In such case, returning to step 161, the player would answer yes to the question of whether he is already entered in the pool. This action results in a prompt 176 wherein the player is asked to enter the pre-assigned security identifier. The identifier is then validated 178 and, if found valid, the player enters 188 the game domain. If the identifier is found invalid, the player is returned to the prompt 176 to enter an identifier.

Once in the pool game domain 188, the pool administrator provides the player with a list of selections in each category and the player is prompted 190 to make a selection for the period's contest, in step 192. Following which, the player is allowed to make a selection 194. As described above, the selection consists of a specific pick, or a range of picks, as determined by the particular game rules. In step 194 the ticket manager 50 issues and stores the ticket in the database 22. After the event takes place in step 196, the pool engine reviews the selections in order to determine 198 at least one winner between the player and the administrator. A determination is made as to whether the previous round was the ultimate round 200. If not, the player is returned to step 190 to make a selection in another period or category.

The play occurs over a pre-specified number of periods. For each period, the players' selections are judged successful or not. Each successful player receives credit for that category. After the last period has been contested, the player who has filled, or obtained credit for all of the categories is deemed the winner 202. If none of the players have filled all the categories, then the player or players who have filled the most categories is/are deemed the winner(s). As indicated above, all players make selections for all periods, regardless of whether they have obtained credit in the previous period. Following this, the pool is closed 204.

As will be noted from the above discussion, when a player returns to the game website for subsequent selections and information, they need only enter their valid security identifier and access the game 188. Thus, as with the previous description, purchasing a ticket and entering the game occurs only at the player's first visit. It will also be noted that the pool information is not updated with every visit and that only a ticket sale affects the pool information. Of course, other variations of the game and access thereto will be apparent to persons skilled in the art.

In another embodiment, a plurality of players may register as a group, and participate as a group in the games 48.

The above-described embodiments of the invention are intended to be examples of the present invention and alterations and modifications may be effected thereto, by those of skill in the art, without departing from the scope of the invention that is defined by the claims appended hereto.

1. A method of playing a pooled-betting game between a plurality of players over a communication network, said pooled-betting game being based on an event, said method having the steps of:
associating each player with a point of access to said game;
coupling said player to a pool engine for processing an entry request to said game, said entry request being associate with payment of an entry fee;
transferring said entry fee from each of said players to a pool;
said pool engine determining a winner of said game in accordance with an outcome of said game; and,
awarding said pool to said winner.

2. The method of claim 1 wherein each player is assigned a unique security identifier upon the first visit to said game and after paying the entry fee.

3. The method of claim 2 wherein said players gain direct access to said game, without payment of an entry fee, by entering said security identifier.

4. The method of claim 1, wherein at least one of said points of access is a website associated with a benefactor, said benefactor hosting said game for a beneficiary.

5. The method of claim 1, wherein at least one of said points of access is a website associated with a beneficiary for accepting a portion of said entry fee.

6. The method of claim 5, wherein said player from a point of access associated with a beneficiary donates a percentage of said portion of entry fee to said beneficiary.

7. The method of claim 5, wherein said player from a point of access not associated with a beneficiary chooses a beneficiary to donate a percentage of said portion of entry fee.

8. The method of claim 5, wherein said beneficiary receives a portion of said entry fee based on the number of players having said beneficiary as a point of access.

9. A method of playing a head-to-head game based on an event, said game comprising the steps of:
(a) presenting at least one game associated with a pool to at least one player;
(b) allowing said at least one player to make an entry associated with payment of an entry fee;
(c) coupling said at least one player to a pool engine for processing said selection;
(d) transferring said entry fee from said at least one player to said pool and updating said pool information, the pool being associated with a total amount of said entry fee;
(e) said pool engine determining the number of selections in said pool and creating pairings of non-matching selections;
(f) said pool engine determining a winner of said pairing based on said at least one player's outcome;
(g) repeating steps (a) to (e) until there exists only one pairing; and
(h) awarding said pool to the winner of the remaining pairing.

10. The method of claim 9, wherein the step of creating pairings of non-matching selections includes a further step of communicating said pairings to said at least one player.

11. The method of claim 9, wherein the step of allowing said at least one player to make selections includes a further step of specifying a predetermined time period for which said player may make said selections.

12. The method of claim 9, wherein said pool engine creates subsequent pairings by pairing winners from previous pairings with one another.

13. The method of claim 11, wherein after the expiry of said predetermined time period, in the event no selection has been made, said pool engine generates a selection and submits said selection on behalf of said at least one player.

14. The method of claim 9, wherein said at least one player remaining after said awarding of said pool continues to play said game.

15. The method of claim 14, wherein said remaining players are eligible for other prizes based on performance.

16. The method of claim 9 wherein each player is assigned a unique security identifier upon the first visit to said game and after paying the entry fee.

17. The method of claim 16 wherein said players gain direct access to said game, without payment of an entry fee, by entering said security identifier.

18. A method of playing a head-to-head game based on an event, said game comprising the steps of:
(a) presenting at least one game associated with a pool to at least one player;
(b) allowing said at least one player to make an entry associated with payment of an entry fee;
(c) coupling said at least one player to a pool engine for processing said selection;
(d) transferring said entry fee from said at least one player to said pool and updating said pool information, the pool being associated with a total amount of said entry fee;
(e) said pool engine determining the number of selections in said pool and creating pairings of non-matching selections;
(f) said pool engine determining a winner of said pairing based on said at least one player's outcome;
(g) repeating the steps of (a) to (e) until there exists only one pairing; and
(h) awarding said pool to the winner of the remaining pairing.

19. The method of claim 18, wherein said step of configuring said pool engine to accept selections from said at least one player further includes the steps of:
a system administrator making a selection for each of said categories;
presenting said administrator's selections for viewing and examining by said players;
said players choosing a category to compete in;
determining whether said players selections outperform the administrator's selection; and,
transferring a credit to each of said players for each category in which their selections outperform that of the administrator; and
repeating the steps for each of said pool periods.

20. The method of claim 19, wherein said presentation of said selection is done at the beginning of each selection period.

21. The method of claim 19, wherein said selection is a made in a predetermined time period before the start of said event.

22. The method of claim 18 wherein each player is assigned a unique security identifier upon the first visit to said game and after paying the entry fee.

23. The method of claim 22 wherein said players gain direct access to said game, without payment of an entry fee, by entering said security identifier.

24. An on-line pooled betting system comprising:
a website site accessible to at least one player, said site having at least one game based on an event and said game including a pool associated therewith;
a pool engine for processing a selection from said at least one player, said selection being associated with payment of an entry fee;
said pool engine being configured to transfer said entry fee from said at least one player to said pool and to update information associated with said pool to said at least one player; and,
a security services component for requesting a security identifier from said player to authenticate said selection.

25. The system of claim 24, wherein said pool is included on a site belonging to a partner affiliated with the system's provider, said partner's website being configured to promote said game.
